(19) United States
(12) Patent Application Publication
(10) Pub. No.: US 2008/0094367 A1
(43) Pub. Date: Apr. 24, 2008

(54) Pressure-Controlled Navigating in a Touch Screen

(75) Inventors: Ramon Eugene Franciscus Van De Ven, Eindhoven (NL); Galileo June Destura, Eindhoven (NL); Michael Heesemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,928

(22) PCT Filed: Jul. 12, 2005
(86) PCT No.: PCT/IB05/52316

§ 371 Date: Jan. 30, 2007

(30) Foreign Application Priority Data
Aug. 2, 2004 (EP) 04103708.6

(51) Int. Cl. G06F 3/041

(52) U.S. Cl. 345/173

(57) ABSTRACT

A remote control device has a display monitor for rendering an image and a touch screen for user interaction. The touch screen is pressure-sensitive. The device has an operational mode wherein the image is being scaled dependent on a value of the pressure registered by the touch screen.

### FIELD OF THE INVENTION

The invention relates to a data processing system with a touch screen positioned over a display monitor for enabling user-interaction with the system.

### BACKGROUND ART

Examples of such a system are disclosed in, e.g., U.S. Pat. No. 6,466,203 (attorney docket US 000173) “HAND-HELD WITH AUTO-ZOOM FOR GRAPHICA LDISPLAY OF WEB PAGE”, and U.S. Pat. No. 6,211,856 (attorney docket PHA 23,387) “GAPHICAL USER INTERFACE TOUCH SCREEN WITH AUTO-ZOOM FEATURE”, both incorporated herein by reference.

U.S. Pat. No. 6,466,203 relates to a mobile phone that has a display monitor with a touch screen. The device has a browser and is capable of retrieving a Web page from the Internet. The page is first displayed in its entirety. The user can recognize the page's general lay-out and presence of hyperlinks. When the user touches a particular location on the touch screen that corresponds to a portion of the page's image, the portion gets displayed so as to fill the display's area. Thus, the user can browse the Web with a display of limited size.

U.S. Pat. No. 6,211,856 relates to a graphical user interface (GUI) “touch screen” having an entire collection of icons displayed at a scale in which the individual function of each icon is recognizable, but too small to easily access features of the function. Upon touching the screen area accommodating an area of the icon, the screen provides a zoomed in version of that area so that the user can select a desired feature.

### SUMMARY OF THE INVENTION

The inventors have realized that the user-friendliness of the known systems can be further increased with regard to navigational and positional operations to be conducted on the user interface by means of giving the touch screen pressure-sensitive capabilities. That is, the touch screen is capable of processing input data representative of the touch location relative to the screen as well as input data representative of a force or pressure that the user exerts on the touch screen in operational use.

To this end, the inventors propose a data processing system with a display monitor for rendering an image and a touch screen for user interaction with the system. The touch screen is pressure-sensitive. Furthermore, the system has an operational mode wherein the image is being scaled dependent on a value of a pressure registered by the touch screen. Preferably, moving a location on the touch screen while touching the touch screen controls a corresponding movement in the image rendered on the monitor.

To clarify this concept, consider for example a GUI for adjusting a virtual slider rendered on a touch-screen-enabled display monitor of a remote control device. The slider controls, e.g., the brightness of an image displayed together with the GUI. In order to adjust the brightness, the slider is to be repositioned within the applicable range. The slider is repositioned by touching, with a finger or a stylus, the location on the touch screen that corresponds with the location on the display monitor where the slider is being rendered, and then dragging the slider to its desired position by moving the finger or stylus accordingly. Especially with regard to displays that are relatively small and with regard to relatively small GUIs, the user may experience some difficulties with positioning of the slider accurately. For example, the finger or stylus may overshoot the desired position, or the spatial dimensions of the GUI do not match the natural scale of the user's movements or size of his/her finger. According to the invention, the user is enabled to adjust the scale of the GUI under control of the magnitude of the pressure exerted during touching the screen.

The system of the invention can be a distributed system, wherein the monitor and touch screen combination is connected to a computer or server via a data network (wired or wireless) such as the Internet. Alternatively, the system of the invention is accommodated in a single apparatus, e.g., a desktop or laptop PC, a palmtop PC, a cell phone, a remote control device or another handheld device.

The invention also relates to a method of enabling user interaction with a data processing system that comprises a display monitor for rendering an image and a pressure-sensitive touch screen for the user interaction. The method of the invention comprises scaling the image dependent on a value of the pressure registered by the touch screen. Preferably, the method also comprises controlling a movement in the image rendered on the monitor in response to detecting a moving of a touch location on the touch screen while the touch screen is being touched. Such a method is relevant to, e.g., a service provider who provides a service via a data network such as the Internet. The service provider receives data representative of a touch location and a touch pressure, and interprets this data as commands to, e.g., scroll or zoom-in/out on an image provided. The image can be a web page, a road map or a menu of user-selectable options, for example.

The invention further relates to control software for use with a data processing system that has a display monitor for rendering an image and a pressure-sensitive touch screen for user interaction with the system. The software is operative to scale the image dependent on a value of the pressure registered by the touch screen. Preferably, the software is further operative to control a movement in the image rendered on the monitor in response to detecting a moving of a touch location on the touch screen while the touch screen is being touched. This embodiment of the invention is relevant to software providers or service providers who enable the user of an electronic device with a pressure sensitive touch screen to upgrade his/her device for convenient navigation.

### BRIEF DESCRIPTION OF THE DRAWING

The invention is explained in further detail, by way of example and with reference to the accompanying drawing wherein:

FIG. 1 is a diagram of a system in the invention;

FIGS. 2 and 3 illustrate a first application of the invention;

FIGS. 4 and 5 illustrate a second application of the invention;

Throughout the figures, same reference numerals indicate similar or corresponding features.

### DETAILED EMBODIMENTS

FIG. 1 is a block diagram of a system 100 in the invention. System 100 comprises a user input device 102 that itself has a display monitor 104, a pressure-sensitive touch screen 106 and a pressure sensor 108. Touch screen 106 is positioned over display monitor 104, but these entities are drawn here as separate components in order to not obscure the drawing. Sensor 108 detects the magnitude of the pressure applied by user 110 to screen 106. System 100 further comprises a data processor 112 that is connected to device 102, e.g., via a data network 114 as in the drawing. In another embodiment device 102 and processor 112 are directly connected, e.g., wirelessly or via a cable, or are integrated with one another within a single physical apparatus such as a cell phone or remote control device, etc. Processor 112 in this example comprises control software 116 to have system 100 operate according to the invention.

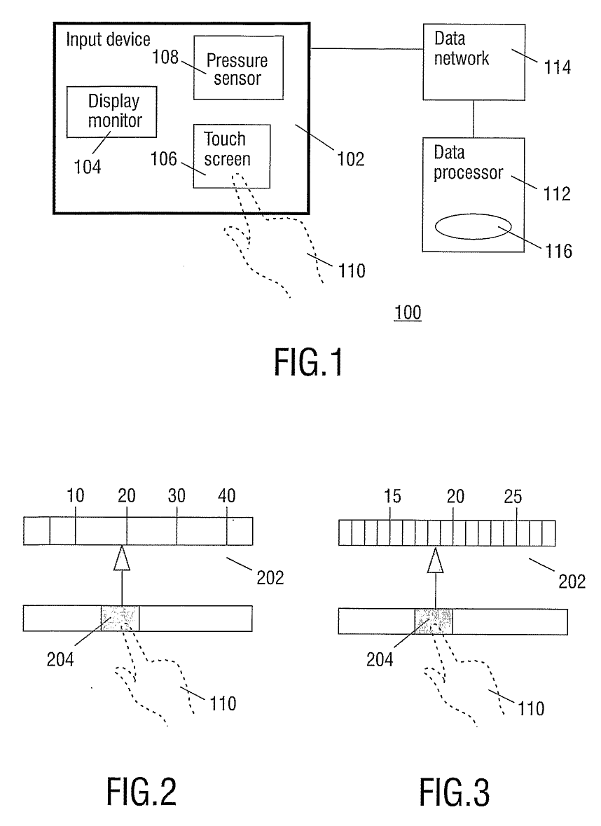

FIGS. 2 and 3 illustrate a first application of the invention. FIG. 2 is a diagram of a GUI rendered on monitor 104 for setting a parameter to a numerical value in a range between 0 and 40. The range is represented in the GUI, e.g., by a line segment of a bar 202 subdivided into segments marked by the relevant decade. A slider 204 is rendered as well with a travel that corresponds with range 202 so as to be able to set slider 204 to any of the relevant values. By touching touch screen 106 at the location of slider 204 and dragging his/her finger across screen 106, user 110 can reposition slider 204 so as to select the parameter's value. FIG. 3 is a diagram illustrating the GUI wherein bar 202 is being displayed at a larger scale in response to user 110 applying a higher pressure to touch screen 106 at the location where slider 204 appears to have been rendered. Moving slider 204 by dragging one's finger now enables to select the numerical value at a finer scale. In the example, slider 204 assumes another color or gray-scale or provides another visual indication representative of the change in magnitude of the pressure applied. This serves as a visual feedback to the user. Once the desired value has been selected through slider 204, user 110 releases slider 204. The example in FIGS. 2 and 3 show two scales at which bar 202 is being displayed. It is clear that three or more scales can be implemented, each specific scale corresponding to a specific range of pressure values. Preferably, a specific range of pressure values determines a specific scale. Instead, a particular pressure value may be used to determine a particular scale, but the pressure value may vary too much during user interaction with touch screen 106.

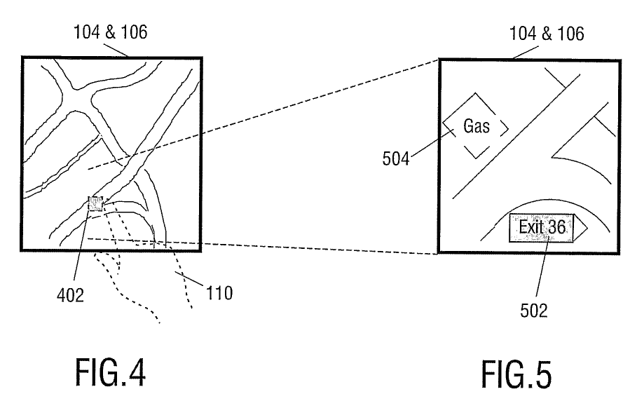

FIGS. 4 and 5 illustrate a second application of the invention. FIG. 4 illustrates monitor 104 rendering a geographic map, e.g., a road map, with which user 110 can interact through touch screen 106 in order to navigate the map. For example, user 110 touches touch screen 106 and drags his/her finger across screen 106. The dragging causes the image of the map to scroll in the direction, e.g., of the dragging or opposite to the direction of the dragging. Releasing one's finger, e.g., upon reaching the boundary of screen 106 or of monitor 104, or upon having reached the desired position, freezes the image. User 110 can reposition his/her finger for further dragging. Alternatively, dragging one's finger across screen 106 controls the path of a cursor 402 within the image of the map. The cursor is rendered underneath the finger or stylus of user 110 and has a size large enough for it to not be obscured by the user's finger. Upon reaching the boundary of the map as made visible on monitor 104, system 100 can gently scroll the map so as to bring a new portion of the map into view for cursor 402 to continue its trip.

When user 110 has reached a desired area of the map, he/she can magnify that area by increasing the pressure on screen 106. When using above scenario wherein the dragging finger causes the image to scroll, the magnified area is the one centered on, e.g., the center of display monitor 104. When using the cursor control the magnified area is centered on, e.g., the location on the map that corresponds with the current touch location as illustrated in FIG. 5.

Preferably, the zooming-in occurs gradually, instead of abruptly, so as to have user 110 not lose his/her orientation with regard to the map. Within this context see, e.g., US published patent application US20010015719 (attorney docket PHA 23,469). This patent documents relates to a remote control device for remote control of home theater equipment. The device has a display with a touch screen representing a GUI. User-activation of the GUI causes its appearance to change. The change is effected through animation. Animation is the simulation of movement created by displaying a series of bitmaps. The animation lets the user perceive the change as a smooth transition. Thus the impression is avoided of an abrupt confrontation with a new layout.

The magnification depends on the pressure registered by touch screen 106. As mentioned above, a specific range of pressure values preferably determines a specific scale, rather than having the scale change continuously in dependence on a continuous change in pressure.

The scale or magnification thus selected is retained upon the user releasing his finger. Alternatively, the user gives an explicit confirmation to signal that the magnification is to be retained. For example, the explicit confirmation is a rapid tapping on touch screen 106 while system 100 maintains the magnification for a short time upon an abrupt decrease of pressure. Other mechanisms can be used to freeze the scale selected.

Once the scale has been selected, changing back to a smaller scale (zooming-out) is caused by the user increasing the pressure above a threshold in order to unlock the scale, or by user 110 increasing the pressure at a rate higher than a certain threshold.

If user 110 has not locked the scale or magnification, reducing the pressure causes the scale to be reduced as well.

The term “magnification”, “zooming” and “scale” as used in this text may also include changing the information content of the portion of the image subjected to the scaling process. For example, each one of selectable items organized in a menu may convey more details regarding its semantic content when magnified in the manner discussed above. Consider, e.g., an electronic program guide (EPG) rendered on the display monitor of a touch screen remote control device. At a first scale, the EPG provides the title of the programs and their times of the broadcast. This information is sufficient for a typical user to decide whether or not there are interesting ones among the programs for closer inspection. Selecting a next higher magnification, e.g., in the manner discussed above, the remote control device renders additional information per program, e.g., a synopsis and the featuring main characters. At yet a next higher level, pictures or graphics are provided representative of the selected programs, etc. As another example see FIG. 5, wherein the magnified portion of the road map includes additional elements such as an indication 502 of a particular exit, and an indication 504 of a gas station.

The term “touch screen” as used in this text is also to include graphical tablets, e.g., stylus-operated. What has been discussed above with regard to touch screens that interact with the user's finger is also applicable to graphical tablets.

1-7. (canceled)

8. A data processing system with a display monitor for rendering an image and a touch screen for user interaction with the system, wherein:
the touch screen is pressure-sensitive;
the system has an operational mode wherein a scale of the image is dependent on a value of a pressure registered by the touch screen and wherein the scale of the image is conditionally retained after a decrease of the value of the pressure.

9. The system of claim 8 operative to retain the scale of the image upon a pre-determined user interaction with the touch screen.

10. The system of claim 8 operative to change back the scale of the image upon a pre-determined user interaction with the touch screen.

11. The system of claim 9, wherein the predetermined user interaction comprises at least one of: applying the pressure having the value above a threshold; increasing the pressure at a rate higher than a further threshold.

12. The system of claim 8, accommodated in at least one of: a remote control device, a cell phone; a handheld PC, a laptop PC.

13. Method of enabling user interaction with a data processing system that comprises a display monitor for rendering an image, and a pressure-sensitive touch screen for the user interaction, wherein the method comprises changing a scale of the image dependent on a value of the pressure registered by the touch screen and conditionally retaining the scale of the image after a decrease of the value of the pressure.

14. The method of claim 13 comprising retaining the scale of the image upon a pre-determined user interaction with the touch screen.

15. The method of claim 13 comprising changing back the scale of the image upon a pre-determined user interaction with the touch screen.

16. The method of claim 15, wherein the predetermined user interaction comprises at least one of: the user applying the pressure having the value above a threshold; the user increasing the pressure at a rate higher than a further threshold.

17. Control software for use with a data processing system that has a display monitor for rendering an image and a pressure-sensitive touch screen for user interaction with the system, the software being operative to change a scale of the image dependent on a value of the pressure registered by the touch screen and to conditionally retain the scale after a decrease of the value of the pressure.

18. The software of claim 17, operative to retain the scale of the image upon a pre-determined user interaction with the touch screen.

19. The software of claim 17, operative to change back the scale of the image upon a pre-determined user interaction with the touch screen.

20. The software of claim 19, wherein the predetermined user interaction comprises at least one of: applying the pressure having the value above a threshold; increasing the pressure at a rate higher than a further threshold.
